(19) United States
(12) Patent Application Publication
(10) Pub. No.: US 2008/0024007 A1
(43) Pub. Date: Jan. 31, 2008

(54) Multiple load hybrid power supply

(75) Inventors: Ramakrishna S. Budampati, Plymouth, MN (US); Anoop K. Mathur, Shoreview, MN (US); Hai D. Pham, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/483,920

(22) Filed: Jul. 10, 2006

(51) Int. Cl. H02J 3/38

(52) U.S. Cl. 307/19

(57) ABSTRACT

A supply-load multiplexer has multiple power inputs for coupling to multiple power supplies and multiple power outputs for coupling to multiple loads. The multiplexer selectively couples the power inputs to the power outputs. A controller is coupled to the supply-load multiplexer and controls the selective coupling of power inputs to power outputs as a function of load power requirements and/or power supply characteristics.

### BACKGROUND

In some systems, such as systems using multiple devices, several power supplies may be used to power the different devices. As systems change, or devices are added or subtracted from the system, the power requirements may change. The power requirements may also change when the devices change their mode of operation. A power supply may be designed to provide power at low levels, or higher levels, or sustainable levels, or at different currents or voltages. Some power supplies, such as batteries, may need frequent recharging if used to power devices with high power requirements. Solar based power supplies may be best suited for devices that use a low amount of power over long periods of time. As can be seen, if the power requirements of a device change, one power supply may not be well suited to continue providing power. Sub-optimal use of power supplies to support multiple loads may lead to increased maintenance costs, such as replacing batteries frequently. It can also lead to inefficient performance of the loads.

### SUMMARY

A supply-load multiplexer has multiple power inputs for coupling to multiple power supplies and multiple power outputs for coupling to multiple loads. The multiplexer selectively couples the power inputs to the power outputs. A controller is coupled to the supply-load multiplexer and controls the selective coupling of power inputs to power outputs as a function of load power requirements and/or power supply characteristics.

### BRIEF DESCRIPTION OF THE DRAWINGS

FIG. 1 is a block diagram of a supply-load multiplexer according to an example embodiment.

FIG. 2 is a detailed block diagram of a supply-load multiplexer according to an example embodiment.

FIG. 3 is a detailed block diagram of a supply-load multiplexer illustrating multiplexed connections between multiple different supplies and loads according to an example embodiment.

FIG. 4 is a flowchart illustrating a process for changing connections between multiple different supplies and loads according to an example embodiment.

FIG. 5 is a flow chart illustrating an algorithm for determining connections between multiple different supplies and loads according to an example embodiment.

FIG. 6 is a block diagram of a typical system for executing methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wireless transmissions as well as different memory devices that can store code. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A supply-load multiplexer is described that has multiple power inputs for coupling to multiple power supplies and multiple power outputs for coupling to multiple loads. The multiplexer dynamically and selectively couples the power inputs to the power outputs. A controller is coupled to the supply-load multiplexer and controls the selective coupling of power inputs to power outputs as a function of load power requirements and/or power supply characteristics. Several embodiments will be described showing different examples of operation of the present invention.

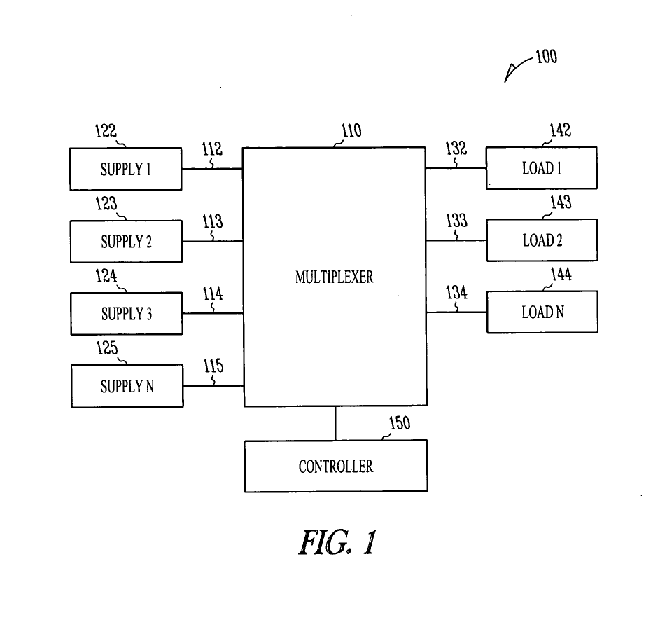

In one embodiment of the invention a hybrid power supply is shown generally at 100 in FIG. 1. The hybrid power supply 100 is formed with a supply-load multiplexer 110 that has multiple power inputs 112, 113, 114, 115 for coupling to multiple power supplies 122, 123, 124, 125 and multiple power outputs 132, 133, 134 for coupling to multiple loads 142, 143, 144. The multiplexer 110 selectively couples the power inputs to the power outputs. A controller 150 is coupled to the supply-load multiplexer and controls the selective coupling of power inputs to power outputs as a function of load power requirements and/or power supply characteristics. The selectively coupling may be done dynamically in response to changing needs of the loads and condition or status of the power supplies. The loads may be directly coupled to the various power supplies in one embodiment, either exclusively or in some instances, multiple loads may be directed coupled to the same power supply. In further embodiments, the number of inputs and outputs may be varied, and need not be equal. Different types of power supplies and different types of loads may be used. Power supply characteristics may be monitored by the controller 150 to determine power availability. The controller may also monitor the states of the loads to determine their expected power requirements, and combine the requirements with the availability to multiplex connections between the power supplies and loads.

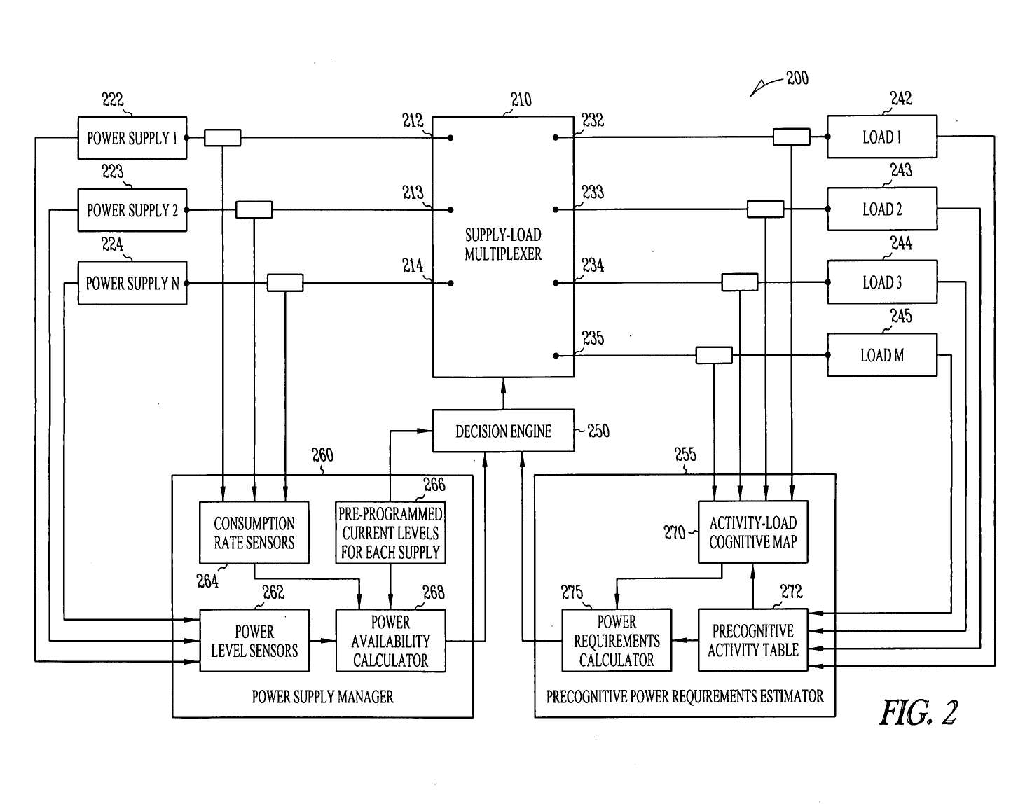

A more detailed block diagram of an alternative hybrid power supply is shown generally at 200 in FIG. 2. The hybrid power supply 200 is formed with a supply-load multiplexer 210 that has multiple power inputs 212, 213, 214 for coupling to multiple power supplies 222, 223, 224 and multiple power outputs 232, 233, 234, 235 for coupling to multiple loads 242, 243, 244, 245. The multiplexer 210 selectively couples the power inputs to the power outputs.

A controller, sometimes referred to as a decision engine 250 is coupled to the supply-load multiplexer 210 and controls the selective coupling of power inputs to power outputs as a function of load power requirements determined at a power requirement estimator 255 and/or power availability calculated at a power supply manager 260. In further embodiments, the number of inputs and outputs may be varied, and need not be equal. Different types of power supplies and different types of loads may be used. Further, the decision engine 250, power requirement estimator 255 and power supply manager may be at least partially implemented in software executing on one or more computers.

The power supply manager 260 may measured power supply characteristics through the use of power level sensors 262. Consumption of power from the various power supplies may be measured by consumption rate sensors 264. The power supplies may also have pre-programmed current levels that they can provide as indicated at 266. A power availability calculator 268 receives information from the power level sensors 262, consumption rate sensors 264 and the current level information from 266, and provides indications of available power from each supply to the decision engine 250. The sensors may take any form now known or developed in the future, and may be hardwired or wireless, battery operated or line powered.

The power requirement estimator 255 receives current load activity information from an activity-load cognitive map 270 in one embodiment. The cognitive map may measure the actual current load consumption characteristics for different statuses of the loads, such as active, idle, sleeping, or in various different forms of operation. The power requirements of such different statuses may also be provided. A precognitive activity table 272 provides information about the expected power use of the loads. This information may take different forms, such as whether a load is actually active, or times during which a load may become active and for how long such activity may occur. The power requirement estimator 255 receives information from the map 270 and table 272 and calculates the power needs, such as how many mAHrs are needed and for how long. It provides this information to the decision engine 255.

Decision engine 255 receives the availability information and the power requirements information from the power supply manager 260 and power requirement estimator 255, and decides how to connect power supplies to loads to provide desired use of the various power supplies to adequately power the loads. In one embodiment, the connections may be provided to optimally use the various power supplies to provide power to the multiple loads.

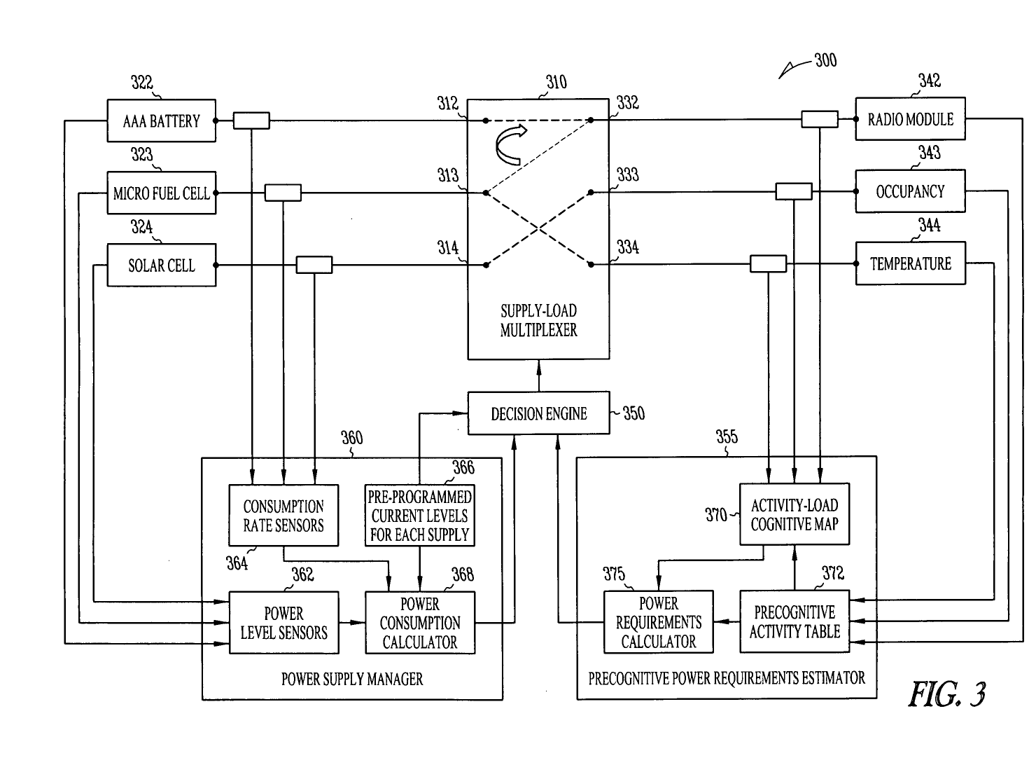

A block diagram of an example hybrid power supply coupled to identified components, and illustrating connections between components is shown generally at 300 in FIG. 3. The hybrid power supply 300 is formed with a supply-load multiplexer 310 that has multiple power inputs 312, 313, 314 for coupling to multiple power supplies such as AAA battery 322, micro fuel cell 323, and solar cell 324. Multiple power outputs 332, 333, 334 are for coupling to multiple loads such as radio module 342, occupancy sensor 343, and temperature sensor 344.

The multiplexer 310 selectively couples the power inputs to the power outputs. In one embodiment, AAA battery 322 is not providing power to any load. Radio module 342, which may currently be in sleep mode, but is known to be switching from sleep to transmit mode in 2 us and stay in transmit mode for 1 ms, is currently powered by the fuel cell 323. Solar cell 324 is coupled via multiplexer 310 to occupancy sensor 333 which may be in an active mode. Micro fuel cell 323 may also be coupled to temperature sensor 344, which is idle.

A controller, sometimes referred to as a decision engine 350 is coupled to the supply-load multiplexer 310 and controls the selective coupling of power inputs to power outputs as a function of load power requirements determined at a power requirement estimator 355 and/or power availability calculated at a power supply manager 360. In further embodiments, the number of inputs and outputs may be varied, and need not be equal. Different types of power supplies and different types of loads may be used. Further, the decision engine 350, power requirement estimator 355 and power supply manager may be at least partially implemented in software executing on one or more computers.

The power supply manager 360 may measured power supply characteristics through the use of power level sensors 362. In this embodiment, example readings determine that the AAA battery 322 has medium power level, fuel cell 323 has high power and solar cell 324 has medium power. Consumption of power from the various power supplies may be measured by consumption rate sensors 364. Current consumptions are 0 mA/ns for the AAA pattery 322, 5 uA/ns for the fuel cell 323 and 1 mA/ns for the solar cell 324. The power supplies may also have pre-programmed current and/or voltage levels that they can provide as indicated at 366. An example of such a current level is 0 to 5 uA for the fuel cell 323.

A power availability calculator 368 receives information from the power level sensors 362, consumption rate sensors 364 and the current level information from 366, and provides indications of available power from each supply to the decision engine 350. For this example, the power consumption for AAA battery 322 is 50 mAHr left for 60 hrs, the fuel cell 323 has 100 AHr left for 20 yrs, and the solar cell has 20 mAHr left for 4 hours.

The power requirement estimator 355 receives current load activity information from an activity-load cognitive map 370 in one embodiment. The cognitive map may measure the actual current load consumption characteristics for different statuses of the loads, such as active, idle, sleeping, or in various different forms of operation. The power requirements of such different statuses may also be provided. In this example, the radio 342 in transmit mode, TX, requires 100 mA, in receive mode, RX, 50 mA, and 5 uA in sleep mode. The Occupancy sensor 343 requires 1 mA in active mode and 5 uA in idle mode. The temperature sensor 344 utilizes 1 mA in active mode and 5 uA in idle mode.

A precognitive activity table 372 provides information about the expected power use of the loads. This information may take different forms, such as whether a load is actually active, or times during which a load may become active and for how long such activity may occur. In this example, the radio is known to be in transmit mode in 2 us for a duration of 1 ms. The occupancy sensor 343 is currently active, and the temperature sensor 344 is idle. The power requirement estimator 355 receives this information from the map 370 and table 372 and calculates the power needs, such as how many mAHrs are needed and for how long. It provides this information to the decision engine 355. In this example, since it is known that the radio 342 will begin transmitting in 2 us, the AAA battery 322 is changed by the decision engine 350 to begin providing power to the radio 342. The fuel cell 323 continues providing power to the temperature sensor 344 and the solar cell 324 continues providing power to the occupancy sensor 343.

Power requirement calculator 375 determines that the radio 342 needs 100 mA for 1 ms, in 2 us. The occupancy sensor 343 will continue needing 1 mA for 1 minute, and the temperature sensor will continue needing 5 uA for 10 seconds. It also calculates how may mAHrs will be needed and for how long for each load. The above calculations are for one example period of time. Conditions will vary as loads are predicted to transition to different modes at different times. The calculations may be done continuously or at various intervals as desired.

The decision to switch the radio 342 to AAA battery 322 power is a function of the expected amount of power required by the various loads, and the abilities of the power supplies to provide the power. The AAA battery 322 has the ability to provide from 0 to 100 mA, while the fuel cell may only provide from 0 to 5 uA as indicated by 366. Thus, the AAA battery 322 is better suited to provide the 100 mA that the radio 342 will need during transmission beginning in 2 μsec. 366, which may be a table or other form of data providing device also indicates a pre-programmed current level of 0 to 75 mA for the solar cell 324. These are just example current levels for example power supplies. The current levels for the supplies may vary, as may the number and type of power supplies which may be utilized. Some loads may be following predetermined schedules and some may react to the environment in which they are located. The precognitive power requirement estimator 355 may take such schedules into account, and may also monitor conditions to predict mode changes of the loads. In further embodiments, the loads may provide the estimator 355 with mode switching information to assist with power supply multiplexing management.

Decision engine 355 receives the availability information and the power requirements information from the power supply manager 360 and power requirement estimator 355, and decides how to connect power supplies to loads to provide desired use of the various power supplies to adequately power the loads. In one embodiment, the connections may be provided to optimally use the various power supplies to provide power to the multiple loads.

Certain power supplies, sensors and loads have been described with reference to an example embodiment. It should be noted that many different power supplies may be used, such as larger or different types of batteries, thermal power supplies, wind power supplies, and many others. Some sensors which may be used to monitor the power supplies include temperature, lux level, vibration, acoustic, ambient, voltage, power level and others. The loads may additionally includes actuators, display devices and many other types of sensors or other devices.

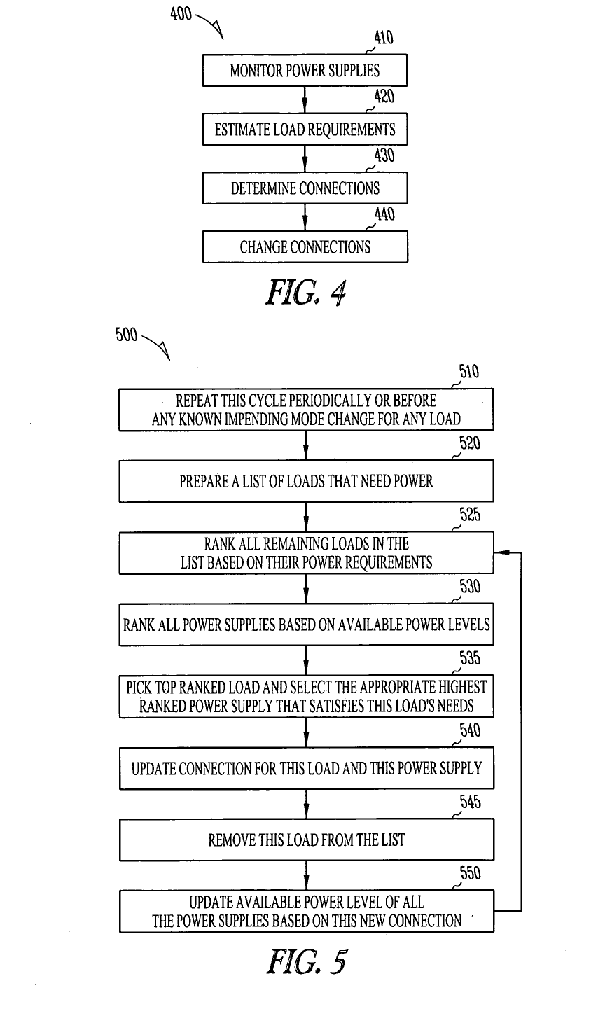

A flow chart illustrating functions of a hybrid power supply in multiplexing supplies and loads is shown generally at 400 in FIG. 4. At 410, power supplies are monitored with respect to their consumption rates and sensors provide power level information. Power requirements for the loads are estimated at 420, and may be based on projected future needs of the loads. At 430, information regarding the power supplies and loads are processed to determine proper supply to load connections to effectively utilize the power supplies and ensure proper operation of the loads. At 440, the multiplexer is controlled to change connections or maintain connection in accordance with the determined connections.

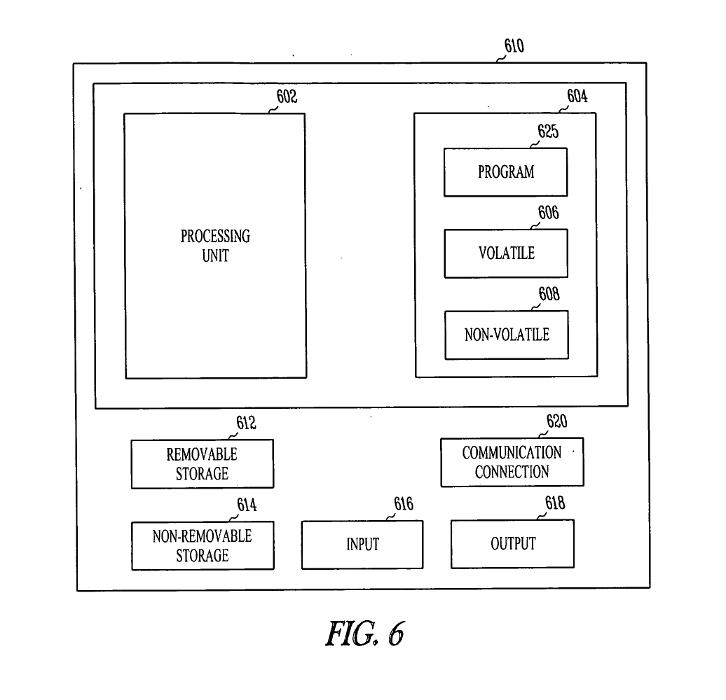

FIG. 5 illustrates one example algorithm at 500 that may be used to determine connections between supplies and loads. Note that voltage converters may be used on the load side to obtain proper voltage levels for the respective loads. In one embodiment, multiple supplies may be coupled to a single load if desired. At 510, the cycle or method is repeated periodically or before any known impending mode change for any load. At 520, a list of loads that need power is prepared. The remaining loads in the list are ranked at 525 as a function of their power requirements. At 530, the power supplies are ranked based on available power levels. The top ranked load is picked, and the highest ranked power supply that satisfies the loads need is then selected. The connection for this load and power supply is then updated at 540, and the load is removed from the list. At 550, available power levels of all the power supplies based on the new connection is updated, and the process returns to 525 to rank the remaining loads. Other algorithms may also be used in further embodiments.

Controller 150, also referred to as a decision engine, along with the power supply manager and power requirement estimator may be implemented via a general purpose or special purpose computer system or systems in various embodiments. A block diagram of such a computer system that executes programming for performing the above algorithm is shown in FIG. 6. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a computer-readable medium. For example, a computer program 625 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 610 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A device comprising:
a supply-load multiplexer having multiple power inputs for coupling to multiple power supplies and multiple power outputs for coupling to multiple loads, wherein the multiplexer selectively couples the power inputs to the power outputs; and
a controller coupled to the supply-load multiplexer that controls the selective coupling of power inputs to power outputs as a function of load power requirements and power supply characteristics.

2. The device of claim 1 wherein the power supplies are selected from the group consisting of AAA batteries, fuel cells and solar cells.

3. The device of claim 1 and further comprising power supply sensors that measure power supply characteristics, wherein the power supply characteristics are selected from the group consisting of current levels, sensed power levels and calculated power consumption of the power supplies.

4. The device of claim 1 where the load power requirements are represented by an activity load map.

5. The device of claim 4 wherein the activity load map identifies different power requirements for the loads as a function of different modes of operation of such loads.

6. The device of claim 5 wherein the different modes of operation of the loads are selected from the group consisting of transmitting, receiving, sleeping, active, and idle.

7. The device of claim 1 wherein the load power requirements are calculated as a function of projected needs of the loads.

8. The device of claim 1 wherein the loads are selected from the group consisting of radios, occupancy sensors and temperature sensors.

9. The device of claim 1 wherein the selective coupling is changed in response to changing load power requirements and changing power supply characteristics.

10. A device comprising:
means for selectively coupling to multiple power supplies to multiple loads; and
means for dynamically controlling the selective coupling of power supplies to loads as a function of load power requirements and power supply characteristics.

11. The device of claim 10 wherein the power supplies are selected from the group consisting of AAA batteries, fuel cells and solar cells.

12. The device of claim 10 and further comprising means for measuring power supply characteristics, wherein the power supply characteristics are selected from the group consisting of current levels, sensed power levels and calculated power consumption of the power supplies.

13. The device of claim 10 where the load power requirements are a function of different modes of operation of such loads and wherein the different modes of operation of the loads are selected from the group consisting of transmitting, receiving, sleeping, active, and idle.

14. The device of claim 10 wherein the load power requirements are calculated as a function of projected needs of the loads.

15. The device of claim 10 wherein the selective coupling is changed in response to changing load power requirements and changing power supply characteristics.

16. A method comprising:
monitoring power supply characteristics of multiple power supplies;
determining future load power requirements for multiple loads; and
selectively coupling multiple power supplies to multiple loads as a function of load power requirements and power supply characteristics.

17. The method of claim 16 wherein the power supplies are selected from the group consisting of AAA batteries, fuel cells and solar cells.

18. The method of claim 16 and wherein power supply sensors are used to monitor power supply characteristics and wherein the power supply characteristics are selected from the group consisting of current levels, sensed power levels and calculated power consumption of the power supplies.

19. The method of claim 16 where the load power requirements are a function of different modes of operation of such loads and wherein the different modes of operation of the loads are selected from the group consisting of transmitting, receiving, sleeping, active, and idle.

20. The method of claim 16 wherein the load power requirements are calculated as a function of projected needs of the loads.
